(19) United States
(12) Patent Application Publication
(10) Pub. No.: US 2017/0253330 A1
(43) Pub. Date: Sep. 7, 2017

(54) UAV POLICING, ENFORCEMENT AND DEPLOYMENT SYSTEM

(71) Applicants: Michael Saigh, Clayton, MO (US); Xiaohong Zhang, Clayton, MO (US)

(72) Inventors: Michael Saigh, Clayton, MO (US); Xiaohong Zhang, Clayton, MO (US)

(21) Appl. No.: 15/061,256

(22) Filed: Mar. 4, 2016

(51) Int. Cl. B64C 39/02; B64D 47/06

(52) U.S. Cl. CPC B64C 39/024; B64D 47/06; B64C 2201/146; B64C 2201/18; B64C 2201/12

(57) ABSTRACT

The described embodiments provide systems and methods for any type, usage, classification of Unmanned Aerial Vehicle (UAV) policing including but limited; detection, compliance to FAA (local, state, federal and global) enforcement and various operational guidelines. The Unmanned Aerial Vehicle Enforcement (UAVE) includes but is not limited to operational and airworthiness guidance for the operation of plurality approved routes and/or route restriction, methods, procedures, Global Positioning Systems, registration (ownership), authorization, cargo and usage approval, breadcrumb trail of flight Departure(s) Procedures and Coordinates (DPCs), and Standard Arrival Procedures and Coordinates (SAPCs) and other systems. UAVE could include for example; one or more UAV and/or operators, enforcement agencies, convergence or divergent systems, CAD systems and performance criteria required for enforcement, application(s), administration, implementation and prosecution. FAA or other governmental UAVE systems could include any software, hardware UAV devices, sensors, communication transmissions and controls, operations, navigation, fining and fees, apprehension and disabling methods and technologies which aid law enforcement.

This application claims priority to U.S. provisional application No. 62/129,075, filed on Mar. 6, 2015, which is incorporated herein by reference as though fully set forth herein.

### BACKGROUND

Presently, airborne drones have proliferated to assist humans, survey land and used for agriculture, used the movie industry, inspect power lines for utility companies, used for special and military operations, logistics, 3-d mapping, reconnaissance, research and development, news gathering, and the used for other industrial and commercial purposes.

Police drones are also deployed to improve public safety. A police application could in a multitude of scenarios: for instance, a suspect in a red car screeching to a halt outside an abandoned farmhouse with two police vehicles, in pursuit. The suspect makes off on foot, waving a large handgun in front of him. The officer launches a UAV, the drone hovers directly over the suspect, streaming images of the man from a high-definition camera down to a mobile computer screen. “I have a visual of the suspect,” an officer says into his radio device. “Positive ID of a gun in his right hand—proceed with caution.”

Another examples, could be putting a drone up over a crime or traffic accident scene to take digital photographs that might provide detectives with useful intelligence from an aerial perspective related to the threat of flooding from the Missouri River, which is an annual hazard in the region; UAV deployed to search for missing people—two victims of drowning and the third a person concussed in a car crash who wandered away from the scene in a daze; a search for two suspected criminals who had escaped from a local jail. The suspect runs into corn stalks eight feet high that made visibility on the ground impossible, and it would have taken a Swat team to hours to search it on foot. So instead they launched over the field, fitted out with a thermal-imaging device that could detect any live presence through body heat. The field was quickly traversed, and found to be empty—though the suspects were not there, the automated search freed up police officers to look elsewhere and the suspects were soon picked up in the surrounding area; an investigation into the rape of two students in their college apartment. Sheriffs wanted to test out a theory that the suspect had stalked his victims for some time, so they flew a drone outside the window of his apartment to show that he had a clear line of sight to the women's premises. The footage, taken by high-definition camera, was of high-enough quality that it could be presented in court as forensic evidence.

There are thousands of similar police (gov.) applications and commercial applications and “compliance”. It is understood by anyone familiar with the art, that the scope of this invention cannot possibly list a fraction of the applications. For the purpose of this UAVE, “compliance” means meeting operational and functional performance criteria and other requirements. Mandatory terms such as “must” are used only to ensure applicability of these particular methods of compliance when the acceptable means of compliance described are used by various government agencies. It is understood by anyone familiar with the art will understand that various regulatory compliance requirements or authorize deviations from regulatory requirements could be dynamically implemented for all UAVE systems.

The problem with the present police deployment and system is that no comprehensive standard, system for UAV apprehension and disablement. HR 658 on UAV and UAS drones includes speed limitations, weight limitations and other FAA airspace requirements. Bills, governmental regulations and the FAA's intent in road-mapping guidelines for public safety against the wrongful or criminal of UAVs is a true reality and should be implemented as soon as possible. However, practical application of apprehending and disabling unlawful drones must be resolved through invention not legislation. The present invention enables law enforcement and emergency responders with mechanisms and tools to detect, disable, disarm, apprehend, detain, capture and hold harmless UAV(s) who have violated or is suspected to violate, harm and injure citizens and endanger public safety.

An unmanned aerial vehicle (UAV), commonly known as a drone and also referred to as an unpiloted aerial vehicle and a remotely piloted aircraft (RPA) by the International Civil Aviation Organization (ICAO), is an aircraft without a human pilot aboard. ICAO classifies unmanned aircraft into two types under Circular 328 AN/190:
Autonomous aircraft—currently considered unsuitable for regulation due to legal and liability issues
Remotely piloted aircraft—subject to civil regulation under ICAO and under the relevant national aviation authority.
   UAVE data capture from, unmanned airborne vehicles could track other UMV's from their origination to one or more arrival designations. UMVE internal processor or external process could securely decimate all forms of data include but not limit to enriched information.
   UAVE traffic control and one or more management network(s) could capture data implemented by federal, state, county and local government(s).

### SUMMARY OF INVENTION

The present disclosure relates to a smart dynamic database which interfaces a plurality of UAVE designs and functions. For example, the UAVE being designed to travel at high-speeds, hover at great altitudes, travel long distances without recharge, withstand harsh winds and weather conditions, others designed to carry heavy payloads, others with sophisticated sensors and communication technologies or a combination of one or more components. One important embodiment of the invention, the invention includes is not limited to for example, the ability of the UAVE system to automatically:
Intercept a UAV which could interfere with a airplane's flight path.
Intercept a UAV carrying illegal drug or substances.
Intercept a UAV carrying bombs or weapons.
Intercept any terrorist UAV.
intercept any UAV who violates the law, from traffic violations, misdemeanors through criminal.
Other UAVE intercepts.

The term “interception” could be defined as the point or coordinate at which a line, curve, surface, airspace, grid intersects a coordinate axis (XY or XYZ); to include or bound (a part of a space or curve) between points or lines. The UAVE could intercept another UAV's communication, flight record, radio transmission etc., in order to prevent a UAV from functioning, traveling, communicating or having access of GPS travel routes. In one embodiment of the invention, the UAVE system could interfere when required with the UAV's GPS coordinate and positioning. In other words, the UAVE system would allow authorized agents or personnel to alter the UAV's GPS coordinates for example, to another GPS coordinate. In another embodiment UAVE could take, seize, or halt a UAV or a UAV on the way from one place to another and cut off one or more UAVs from an intended destination.

The UAVE system's functions could include but is not limited to the following examples:
(I) Secretly, listen to or record (a transmitted communication received or transmitted) by the UAV.
(II) Stop or interrupt the course, progress, communication and transmission of the UAV(s).
(III) Take possession of the UAV.
(IV) Stop or check passage, travel, route, cargo, registration, etc. of the UAV.
(V) Catch up to destroy, re-route, capture, host, land, escort a UAV.
(VI) Mark, tag and or identify UAV'(s).
(VII) Intersect (defined above).
(VII) Prevent and or disable the operation or effect of the UAV.
(IX) Cut off from access, sight of UAV.
(X) Intercepted communication of the UAV for public safety.
(XI) Efficiently intercepted, track or follow the UAV through various segments of a UAVs curve or route line.
(XII) Measure the origin to the point at which a curve or line intersects an axis.
(XIII) UAV vehicle recognition.
(XIV) Interception data time-stamping and recording.
(XV) Track the UAV's breadcrumb trail of flight Departure(s) Procedures and Coordinates (DPCs), and Standard Arrival Procedures and Coordinates (SAPCs) and other systems.
(XVI—Other, etc.) could represent a plurality of UAVE's could be activated from various physical standby base stations, for defense, operations, UAV re-charging, drone deliveries, information exchange, law enforcement, critical deliveries, re-routing etc. One example, could be encompass various systems and methods to re-program UAV routes in order to redirect they're path in order to make the route more efficient (weather conditions for example), re-charge the UAV through the bay station if needed, utilize mechanical repair technology if required, disarm a UAV, inspect a UAV, or re-route a UAV in order to enforce public safety.

The UAVE system could include any type of sensor or equipment, including but not limited to gyroscopes, motion detection, chemical, thermal (night vision), high-definition video and audio, x-ray, radar, heat, lumens, GPRS, mechanical, electrical, software, control system, software, mapping, programming, automation or manual controls, a plurality of mobile devices, links, Internet access and sites, communication and transmission devices, etc.

The UAVE system could be capable of reading any FAA required registration signal installed on any UAV if required by the law. For example, the scope of this invention could include legislation which requires some or all UAV's register information in regards to the owner of the vehicle, usage, coordinates and flight path(s), communication etc., exemplified by the following hypothetical FAA registration process Table 1:

### Registration

The UAV owners or organizations name, address, social security number, tax ID number and or various biometric data.
The type of UMV, manufacturer (#) and model #.
The description; weight, AMPs and Volts, equipment exp.; (GPS capabilities, camera model #, etc.).
Other registration requirements.
   Mission's Purpose (what individual, commercial or industrial Use)
Field of Use exp.; agriculture, film, delivery, etc.
Cargo classification (SIC/NAICS) description, weight, other information.
Other specific functions and purposes.

### Flight Coordinates Departure and Arrival(s)

UAV flight Departure(s) Procedures and Coordinates (DPCs), and Standard Arrival Procedures and Coordinates (SAPCs) and other systems.
GPS (DPC/SAPC), GPRS

### Communication

Register (owner) of UAV in communication with UAVE system and network through a secure cloud network.
Alerting and warning system to owners of UAV.
Ticketing and fining Owner.
Capturing DDIC UAV data.
In addition, FAA policy that voice and tamperproof data recorders could be required housed and built-in to the UAV or attached. The rule also allows operators who install combined voice and data recorders, etc. to mount one of those combined recorders in the UAV. The UAVE system could communicate with the UAV, in order to redirect the UMV path when required.
Other communications.

Table 1, describes a hypothetical FAA registration process. Anyone familiar with the art will understand that FAA laws, state laws and local governmental laws could have a multitude of reiterations. It is also understood by anyone familiar with the art that the advancement of UAV technologies could result in changes in FAA requirements and laws in order to enforce new aerial drone technologies. With that understanding in mind, the UAVE system could utilize any UAV technology for enforcement. The uniqueness of one embodiment of the invention is based on UAVE enforcement of various registered and unregistered UAVs. If the law does not require registration the UAVE system could still deploy, detect and disable, seize and enforce. The following exemplifies one embodiment of the invention indicated by:

Enforcement

I. Detection and Restrictions
UAVE determines geographic, topographic UAV public safety vulnerability.
UAV location and route through GPS and radar, etc.
UAVE Interception and deployment of police, Gov. Agents and responders.
UAVE location detection, ID or no registration UAV verification.
UAVE could be equipped with mechanical and or electrical arms which could have the capability of disarming the UAV, hold, in place the UMV or escort the UAV to a holding bay station for examination, investigations and probing through various sensors. The importance of overpowering the UAV and rendering it harmless id an important embodiment of the invention. If the UAVE system cannot disarm a UAV equipped with a bomb or other device, it could endanger the public. Furthermore if the UAV cannot be escorted to a safe and secure location. It could fall and potentially destroy a neighborhood, building, industrial campus, airport, airplane or government building. UAVs could be used as a weapon of terrorism and the UMVE system could both disarm or re-direct the UAV to an area which could save lives and lessen destruction.
UAVE sensors could include but not limited to: Acoustic, Sound, Vibration; Geophone, Hydrophone, Lace Sensor a guitar pickup, Microphone, Automotive, transportation; Air-fuel ratio meter, Blind spot monitor, Crankshaft position sensor, Curb feeler, used to warn driver of curbs, Defect detector, used on railroads to detect axle and signal problems in passing trains, Engine coolant temperature sensor, or ECT sensor, used to measure the engine temperature, Hall effect sensor, used to time the speed of wheels and shafts, MAP sensor, Manifold Absolute Pressure, used in regulating fuel metering, Mass flow sensor, or mass airflow (MAF) sensor, used to tell the ECU the mass of air entering the engine, Oxygen sensor, used to monitor the amount of oxygen in the exhaust, Parking sensors, used to alert the driver of unseen obstacles during parking maneuvers, Radar gun, used to detect the speed of other objects, Speedometer, used measure the instantaneous speed of a land vehicle, Speed sensor, used to detect the speed of an object, Throttle position sensor, used to monitor the position of the throttle in an internal combustion engine, Tire-pressure monitoring sensor, used to monitor the air pressure inside the tires, Torque sensor, or torque transducer or torquemeter measures torque (twisting force) on a rotating system, Transmission fluid temperature sensor, used to measure the temperature of the transmission fluid, Turbine speed sensor (TSS), or input speed sensor (ISS), used to measure the rotational speed of the input shaft or torque converter, Variable reluctance sensor, used to measure position and speed of moving metal components, Vehicle speed sensor (VSS), used to measure the speed of the vehicle, Water sensor or water-in-fuel sensor, used to indicate the presence of water in fuel, Wheel speed sensor, used for reading the speed of a vehicle's wheel rotation, Chemical Breathalyzer, Carbon dioxide sensor, Carbon monoxide detector, Catalytic bead sensor, Chemical field-effect transistor, Electrochemical gas sensor, Electronic nose, Electrolyte-insulator-semiconductor sensor, Fluorescent chloride sensors, Holographic sensor, Hydrocarbon dew point analyzer, Hydrogen sensor, Hydrogen sulfide sensor, Infrared point sensor, Ion-selective electrode, Nondispersive infrared sensor, Microwave chemistry sensor, Nitrogen oxide sensor, Olfactometer, Optode, Oxygen sensor, Ozone monitor, Pellistor, pH glass electrode, Potentiometric sensor, Redox electrode, Smoke detector, Zinc oxide nanorod sensor, Electric Current, Electric Potential, Magnetic, Radio; Current sensor, Daly detector, Electroscope, Electron multiplier, Faraday cup, Galvanometer, Hall effect sensor, Hall probe, Magnetic anomaly detector, Magnetometer, MEMS magnetic field sensor, Metal detector, Planar Hall sensor, Radio direction finder, Voltage detector, Environment, Weather, Moisture, Humidity, etc.; Actinometer, Bedwetting alarm, Ceilometer, Dew warning, Electrochemical gas sensor, Fish counter, Frequency domain sensor, Gas detector, Hook gauge evaporimeter, Humistor, Hygrometer, Leaf sensor, Pyranometer, Pyrgeometer, Psychrometer, Rain gauge, Rain sensor, Seismometers, SNOTEL, Snow gauge, Soil moisture sensor, Stream gauge, Tide gauge. Flow, fluid velocity; Air flow meter, Anemometer, Flow sensor, Gas meter, Mass flow sensor, Water meter, Ionizing Radiation, Subatomic Particles; Bubble chamber, Cloud chamber, Geiger counter, Neutron detection, Particle detector, Scintillation counter, Scintillator, Wire chamber. Navigation Instruments; Air speed indicator, Altimeter, Attitude indicator, Depth gauge, Fluxgate compass, Gyroscope(s), Inertial navigation system, Inertial reference unit, Magnetic compass, MHD sensor, Ring laser gyroscope, Turn coordinator, TiaLinx sensor, Variometer, Vibrating structure gyroscope, Yaw rate sensor. Position, angle, displacement, distance, speed, acceleration; Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Position sensor, Rate sensor, Rotary encoder, Rotary variable differential transformer, Selsyn, Shock detector, Shock data logger, Tilt sensor, Tachometer, Ultrasonic thickness gauge, Variable reluctance sensor, Velocity receiver, Optical, Light, Imaging, Photon; Charge-coupled device, Colorimeter, Contact image sensor, Electro-optical sensor, Flame detector, Infra-red sensor, Kinetic inductance detector, LED as light sensor, Light-addressable potentiometric sensor, Nichols radiometer, Fiber optic sensors, Optical position sensor, Photodetector, Photodiode, Photomultiplier tubes, Phototransistor, Photoelectric sensor, Photoionization detector, Photomultiplier, Photoresistors, Photoswitch, Phototube, Scintillometer, Shack-Hartmann, Single-photon avalanche diode, Superconducting nanowire single-photon detector, Transition edge sensor, Visible light photon counter. Wavefront sensor, etc. Pressure; Barograph, Barometer, Boost gauge, Bourdon gauge, Hot filament, ionization gauge, Ionization gauge, McLeod gauge, Oscillating U-tube, Permanent Downhole Gauge, Piezometer, Pirani gauge, Pressure sensor, Pressure gauge, Tactile sensor, Time pressure gauge. Force, Density, Level; Bhangmeter, Hydrometer, Force gauge and Force Sensor, Level sensor, Load cell, Magnetic level gauge, Nuclear density gauge, Piezoelectric sensor, Strain gauge, Torque sensor, Viscometer. Thermal, Heat, Temperature: Bolometer, Bimetallic strip, Calorimeter, Exhaust gas, temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon bandgap temperature sensor, Special sensor microwave/imager, Temperature gauge, Thermistor, Thermocouple, Thermometer, Pyrometer, Proximity, Presence, Alarm/Alert/Siren sensor(s), Doppler radar, Motion detector, Occupancy sensor, Proximity sensor, Passive infrared sensor, Reed switch, Stud finder, Triangulation sensor, Touch switch, Wired glove. Sensor Technology; Active pixel sensor, Back-illuminated sensor, Biochip, Biosensor, Capacitance probe, Catadioptric sensor, Carbon paste electrode, Digital sensors, Displacement receiver, Electromechanical film, Electro-optical sensor, Fahry-Pérot interferometer, Fisheries acoustics, Image sensor, Image sensor format, Inductive sensor, Intelligent sensor, Lab-on-a-chip, Leaf sensor, Machine vision, Microelectromechanical systems, Photoelasticity, Quantum sensor, Radar, Ground-penetrating radar, Synthetic aperture radar, Radar tracker, Sensor array, Sensor fusion, Sensor grid, Sensor node, Soft sensor, Sonar, Staring array Transducer, Ultrasonic sensor, Video sensor, Visual sensor network, Wheatstone bridge, Wireless sensor network. Other Sensors and Sensor Related Properties and Concepts; Actigraphy, Analog image processing, Atomic force microscopy, Atomic Gravitational Wave Interferometric Sensor, Attitude control (spacecraft), Horizon sensor, Earth sensor, Sun sensor, Catadioptric sensor, Chemoreceptor, Compressive sensing, Cryogenic particle detectors, Dew warning, Diffusion tensor imaging, Digital holography, Electronic tongue, Fine Guidance Sensor, Flat panel detector, Functional magnetic resonance imaging, Glass break detector, Heartbeat sensor, Hyperspectral sensors, IRIS (Biosensor), Interferometric Reflectance Imaging Sensor, Laser beam profiler, Littoral Airborne Sensor/Hyperspectral, LORROS, Millimeter wave scanner, Magnetic resonance imaging, Moire deflectometry, Molecular sensor, Nanosensor, Nano-tetherball Sensor, Omnidirectional camera, Optical coherence tomography, Phase unwrapping techniques, Positron emission tomography, Push broom scanner, Quantization (signal processing), Range imaging, Scanning SQUID microscope, Single-Photon Emission Computed Tomography (SPECT), Smartdust, SQUID, Superconducting quantum interference device, SSIES, Special Sensors-Ions, Electrons, and Scintillation thermal plasma analysis package, SSMIS, Special Sensor Microwave Imager/Sounder, Structured-light 3D scanner, Sun sensor, Attitude control (spacecraft UAV, UAVE), Superconducting nanowire single-photon detector, Thin-film thickness monitor, Time-of-flight camera, TriDAR, Triangulation and LIDAR Automated Rendezvous and Docking, Unattended Ground Sensors, other UAVE sensor detection, monitoring, alerting and bi-directional transmissions. It is understood by anyone familiar with the art that one or more sensors could be installed in a plurality or UAVE, drones. It is also understood that a UAVE drone could be customize to monitor, detect various types of situations, occurrences or events, patrol, etc. It's understood by anyone familiar with art that all applications, protocols, data base sensor(s), etc. could be implemented through one or more UAVE system(s).

In addition, UAVE used by enforcement could capture, gather and analyzes a multitude of Digital Data Identification Capture (DDIC) sources. GPS or AVL positioning and other inputs for the purpose of expeditious response by individual and or a plurality of autonomous or human control UAVE applications. In addition, the UAVE could in one embodiment interface mobile smart devices as well as can be accessed bi-directionally by all mobile devices or controlled and or managed by all mobile smart devices. UAVE could interface secure smart mobile devices as well as one or more control commands from various central stations or a combination of both. Traffic control and management network data capture implemented by federal, state, county and local government, red light enforcement cameras data capture, private security cameras data capture, public safety cameras placed in parks, downtown and municipal geographies, retail districts, school campuses, industrial parks, etc., inputs, UAV License Plate Recognition systems used by law enforcement on police vehicles to capture and analyze license plate data to identify known offenders, wanted persons, sex offenders, stolen vehicles, etc., inputs, Web cams data capture, Audio data capture, Thermal and night (other frequencies) vision data capture, Forensic UAV recognition data capture, RFID and other frequencies capture as exemplified by smart license plates and embedded vehicle tags data capture, Satellite imagery capture, Systems designed to track capture data from individuals or groups of persons, Systems designed to capture data from track livestock or other animals, vehicle tracking systems data capture, systems designed to capture and track payloads or specific items, vehicle recognition, drone airborne, amphibious, road vehicles data capture. Unmanned Public Safety Vehicles (UPSV) and or UAVE, unmanned mobile vehicles, multiple unmanned mobile vehicles, driver and passenger location, single or multiple route locators by UAV traffic, single or multiple route locators by vehicle traffic, single or multiple route locators by unmanned aerial traffic, single or multiple route locators, single or multiple route locators by unmanned rail traffic, single or multiple route locators by unmanned road vehicle traffic, gunshot and protection technology, Bomb blast technology, technology related to motion detector(s), alert tracking, UAV to UAV (vehicle to vehicle) operations. The invention could include smart wearable(s) and smart webcam(s), Nano technology, Other DDIC alerts and applications.

The UAVE system could decrease the time of both emergency and non-emergency response regarding the variables such as but not limited to:
Integrating a fragmented communication system in or to increase efficiencies.
Provide better standards and protocols.
Notify the public through personal alerts customized to their lifestyle.
Customize private sectors alerts in order to better suit their business needs and safety.
Integrate user initiated mobile alerts with stationary alerts to increase privacy for citizens.
Increased safety through minimum loss of human rights.
Maximize inputs from several government sources, from all sectors in order to delineate critical emergency alerts to non-emergency alerts.

UMVE data capture enabled by technological advances in communication networks, Internet and wireless data transfer speeds, combined with increases in server capacity, advances in digital photographic and video images and other technologies of digitized images, multitude of public and private sources, Images, video and other identification sources are generated from, large scale independent and networked systems as well as smaller “stand-alone” devices or networks.

DDIC descriptions, figures and definitions will be presented in the following embodiments: In addition, various wireless LAN controllers providing system-wide WLAN functions such as intrusion prevention, RF management, encryption, DDIC integrity, quality of service (QoS) and mobility could be used in the scope of the current invention. In addition, anyone familiar with the art would recognize that one or more databases, routers, servers, controllers, switches, etc., could be utilized when transmitting DDIC captured data through WAN/Internet configurations or that multiple, independent databases could be manually or dynamically combined for a specific application. A combination of one or more elements of DDIC ALERT could be utilized for any non-emergency or emergency situation and/or event. The DRMS system could also customize each alert in order to tailor the alert and or response to the need and to help prevent the loss of individual freedom, by erasing or clearing resolved situations which are not required for follow up or a court of law and proceedings. DDIC inputs and alerting could transpire in real-time or near-time depending on the severity, sources, number of inputs and need. Defines various sources of Digital Data Identification Capture (DDIC) and Bi-directional ALERTS derived from a plurality of sources. The captured data could be transmitted through both wireless and wireland means. Digital Relay management System (DRMS) could be defined as a communication management system, which could establish communication rules and standards for a plurality of various inputs, data feeders and sources. DDIC could obtain data through multiple inputs. DDIC inputs from a plurality of access points for the data and location-based services necessary for one or more Unmanned Vehicle(s) (UAVs).

In addition, monitoring and management software could be implemented in order to track a multitude of one or more UAV's NFC (RFID data inputs). Active RFID uses electromagnetic signals to uniquely distinguishes and identify a mobile “TAG” device or stationary TAG device. The active RFID identification system tag has its own power source enabling the unit to broadcast an identifying signal. This extends the range of the tags and capability of communicating advance data such as location and other pertinent information and broadcasts an identifying signal. Passive RFID tags are not powered and rely on active signals from location transmitters for their response. RSSI (Received Signal Strength Indication) is an algorithm that determines the location of an active tag by measuring the power of the radio signals or wireless communication outside of conventional WiFi such as but not limit to any and or air-grids. TDOA (Time Difference of Arrival) is an algorithm that determines the location of active tags by measuring the power of radio signals in real-time. Some RSSI systems have choke-point capabilities to provide an instantaneous notice that a tag passed a certain point.

The communication equipment connects to a main communication system of the cellular phone system through a various mean include but not limit to, a Mobile Telephone Switching Office (MTSO) or Mobile Switching Center (MSC). The phrase “public land mobile network (PLMN)” will be used to represent the entire mobile device communication network, regardless of the type of technology used in the communication network (e.g., GSM, GPRS, PCS, CDMA, UMTS, LIT etc.). The PLMN might typically control any base station with which it is in communication, and might handle connections from cellular tower to cellular tower and from a cellular tower to the normal land-based phone system. While the term “cell” or “cellular” is used herein to refer to a certain type of mobile device communication protocols, this term is used in its broadest sense to include other communications systems such as personal communications service (“PCS”) protocol, and the Global System for Mobile communications (“GSM”) protocol, or other similar communications protocols.

UAVE could interface cellular phones, switching cells and, thus, towers, as the phone is moved between geographic areas, allowing constant communication with the PLMN. UAVE(s) could control an interface all FAA data regarding but no limit to registration, detection and scanning, restriction and enforcement, etc. for all UAVs. Typically, a cellular phone, smart phone, satellite phone or any other type of handheld device has one or more codes associated with it, used to identify the specific phone, the phone's owner and the phone's service provider. In addition, nano demarcation particles, could be administered from an unmanned or manned squad vehicle to another vehicle in order to distinguish and track the vehicle or drone. The administration of nano particles could be through various methods, such as but not limited to a high pressured device attached to the front of the squad car and triggered robotically or manually. The nano “sprayed” car could be detected by infrared, and other wavelength spectrums and other devices such as for example, night vision. It is understood by anyone familiar with the art that nano particles could consist of any materials, formula or substance including a bonding material which permanently or temporarily adhere to a vehicle. When a DDIC readable device detects a vehicle which has been “sprayed” an alert could be sent to various mobile devices which could intercept the vehicle. A vehicle in this example could be any unmanned or manned motorized transportation entity.

A system of tracking UAV(s) or its registered agent could include one or more UAV(s) and its associated counterpart(s). UAV(s) could be integrated with an analytical or predictive software component to determine or estimate possible points of origin, routes of travel or proximity to a specific events or locations.

### BRIEF DESCRIPTION OF THE DRAWINGS

FIG. 1 shows a communication network wireless and wireland network, which can transfer information from a plurality of UMVEs and public networks which could locate and transmit data or various commands to a non-governmental UMV communication and an Internet Web based (TCP/IP) infrastructure and network conductivity between drone vehicles with embodiments of the present invention;

FIG. 2 shows a representation of UMVE and network, which are have tracked through a plurality of various senor applications detected a drone (UMV) in flight navigation mode, in accordance with embodiments of the present invention;

FIG. 3 shows a representation of a UMV binging scanned through one or more UMVEs through a plurality of radar, GPS and other sensors in accordance with embodiments of the present invention;

FIG. 4 shows and exemplifies a UAV flight grid and route detected and intercepted by UAVEs as it pertains to a commercial or privately owned (UAVs) and governmental (UAVEs) and a plurality of communication systems with embodiments of the present invention;

FIG. 5 represents examples of UAVEs restricting and disabling a commercial or privately owned UMV with embodiments of the present invention;

FIG. 6 represents various UMVE standby hubs or centers with embodiments of the present invention;

FIG. 7 shows a block diagram example for a multitude of UMVE functions which ranges from minor traffic violations to serious crime actives, responses, deployment and enforcement with embodiments of the present invention.

### DETAILED DESCRIPTION OF THE DRAWINGS

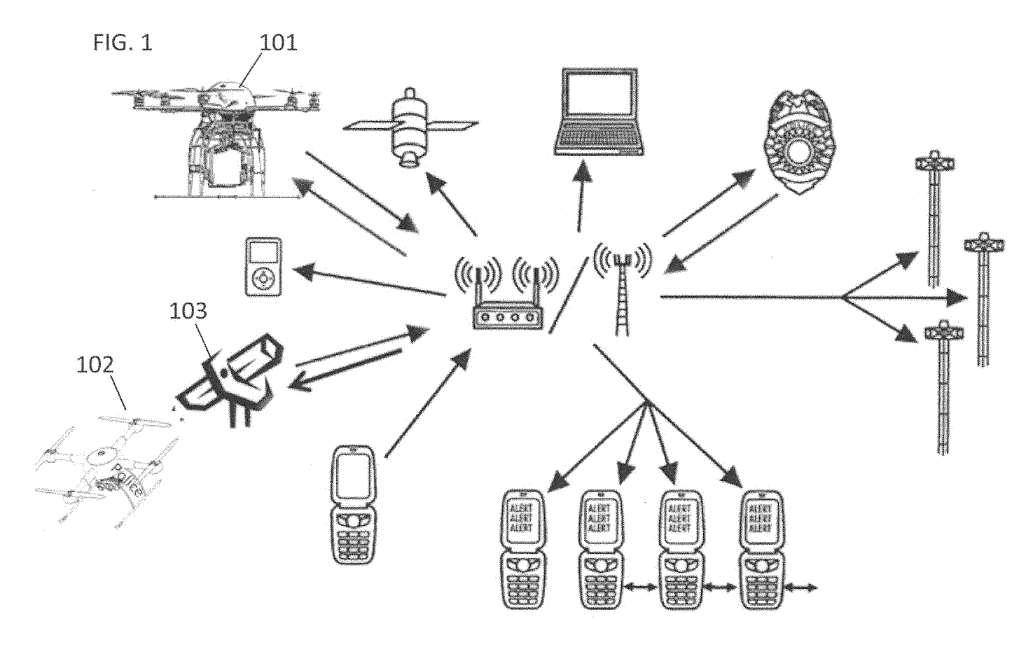

FIG. 1 shows and example of a communication network wireless and wireland network, which can transfer information from a plurality of UMVEs and public networks which could locate and transmit data or various commands to a non-governmental UMV communication and an Internet Web based (TCP/IP) infrastructure and network conductivity between drone vehicles with embodiments of the present invention; 101 represents on or more UAV which could interface with the network and 102 the UAVE drone vehicle through the secure network. 103 represents a secure and encrypted bi-directional command communication transmission(s) between authorized police, gov. etc. drones.

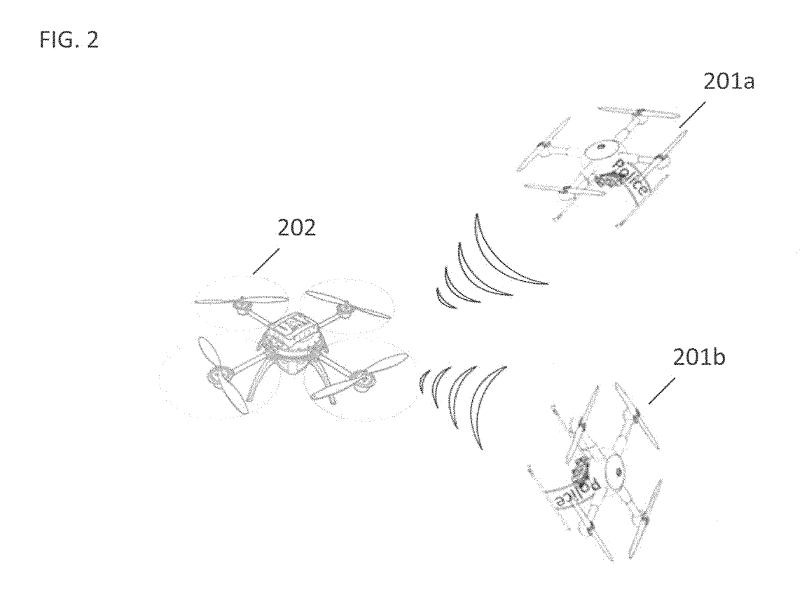

FIG. 2 represents an example one or more UAVs (202) detected through radar, GPS etc., and intercepted through one or more UAVE drones (201a/201b).

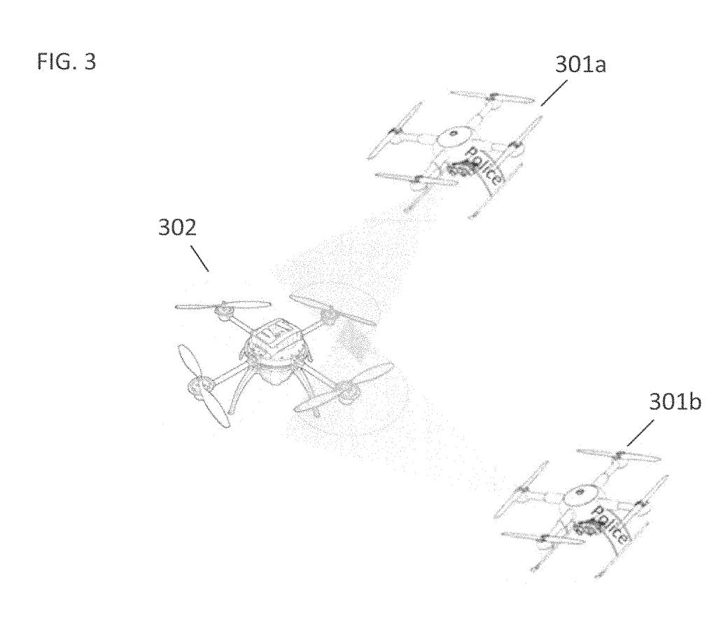

FIG. 3 shows an example of a UAV drone equipped with sensors to scan and probed by a plurality of UAVE vehicles (301a/301b).

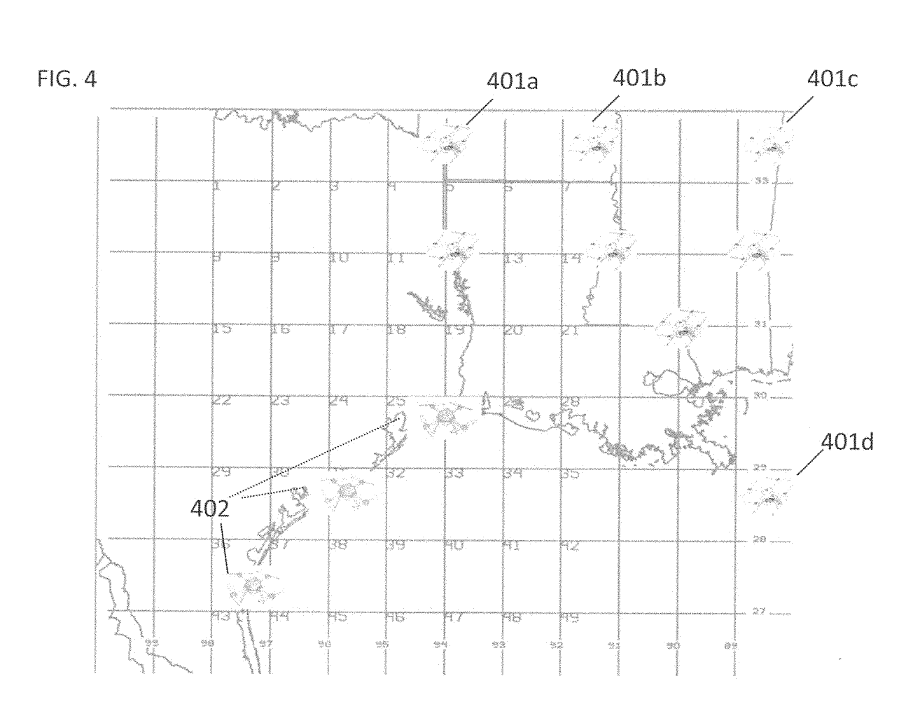

FIG. 4 shows an example or a breadcrumb trail of flight Departure(s) Procedures and Coordinates (DPCs-UAV) and Standard Arrival Procedures and Coordinates (SAPCs-UAV and other systems (402). UAVE could include for example converge from various intersect on the curve as previously described 401a, converging and intersecting the UAV from one coordinate, 401b, c, d intersecting the UAV from another coordinates. All could create a dynamic and efficient communication, and interrelated interception and enforcement intercept with 3^{rd} party vehicles.

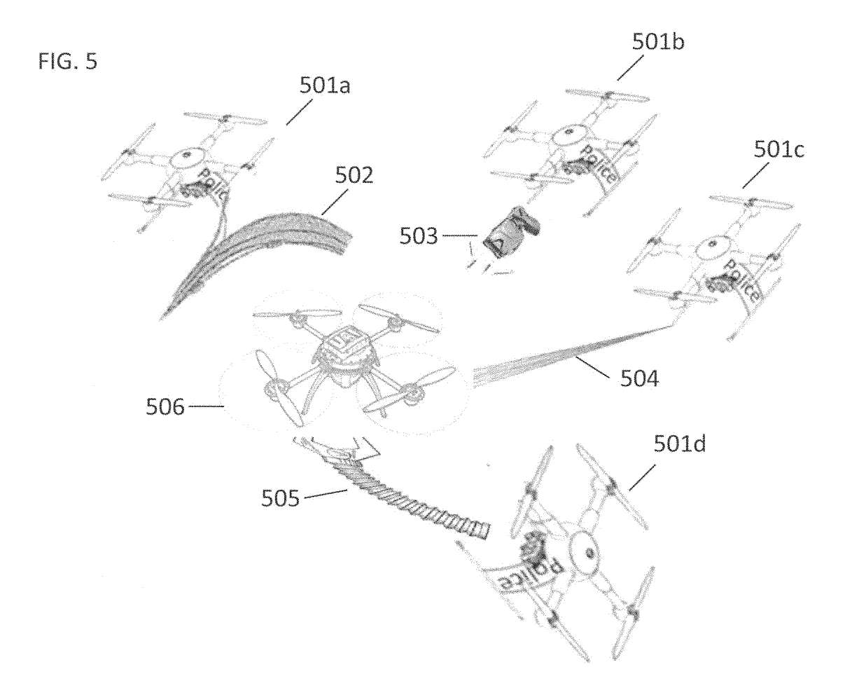

FIG. 5 represents an example of various enforcement units 501 (a, b, c, d) disarmament and restraint designs in or to enforce FAA laws and to protect public safety. 502 represents a drawing which could capture and or disarm a UAV 506, through specialized nets, webs and other architectures which could envelope the UAV for safe escort. This could include but is not limited to any material, design and constraints to cover, encompass and retrain one or more UAVs. UAVE scanners and lasers 504 in conjunction with 501c could be implemented as well to render the UAV harmless and to disable its mobility. 501d represents a mechanical arm which could grab and hold the UAV in order to control its movements and flight path. The UAVE system could utilize any sensor and mechanical means 505 required to capture and control a UAV which for example is suspected to violate public safety. The mechanical arm 501d could be automated through one or more UAME units or manually controlled and operated. 501a represents a UAVE unit which could electronically disable 503 the UAV through electrically generated and or tethered means of disarming and or electronic magnetic pole. It is understood by anyone familiar with the art that UMAE units could both capture, disarm, re-route, safely enforce, guide and escort one or more UAVs.

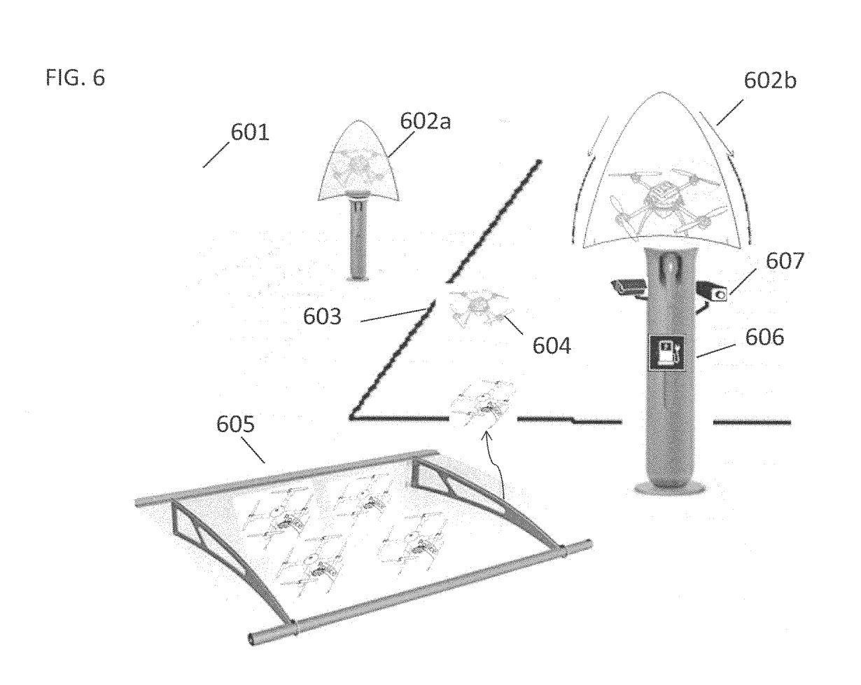

FIG. 6 shows and example of a bay station (stand-by-station) airspace grid 601. 603 represents points of curve or XY(X) intercepts. In addition, grid could include for example, one or more bay-stations which could be strategically located to respond to emergency or situational events including non-emergency events. 605 exemplifies a multipurpose UAVE warehouse containing UMVE or UMVs 604. This purpose of the warehouse could be for mechanical repair of the UAV, multiplicity of deployment, tracking, recharging and or protection from a multitude of conditions including but not limited to weather, etc. 602 exemplifies a protective and retractable dome (or other configuration) bay-station/standby-station. The station could employee various protection technologies, such as but not limited to one or more surveillance video cameras 607, motion detectors or other sensors which could protect the station from intruders. In addition, 606, exemplifies various, means of recharging the UAV's. It is understood by anyone familiar with the art that electrical recharging could be from a power utility grid, solar, wind or other means. In addition, both 605 and 602B represents examples of protected covers, shields, structures which could open in order to release one or more UAV unit(s).

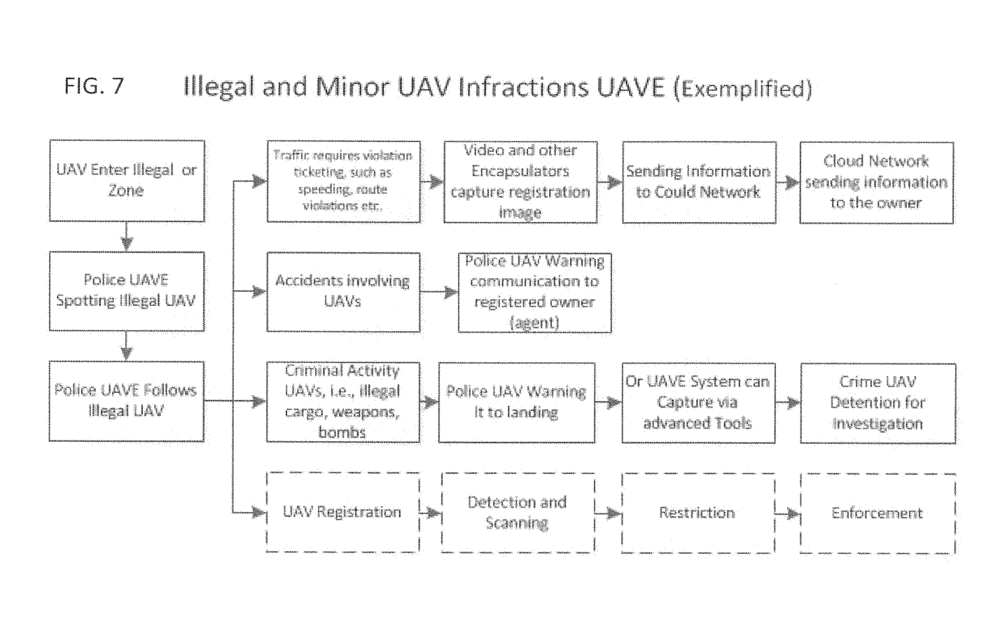

FIG. 7 represents a block diagram which exemplifies UAVE enforcement including traffic tickets, minor infractions to criminal activity. Included are examples of registration, detection, restriction etc. as previously described.

Given these concepts above, this Summary is provided to introduce a selection of embodiments in a simplified form that are further described below. This Summary is not intended to identify key features or essential features of any claimed subject matter, nor is it intended to be used to limit the scope of any claimed subject matter.

Described embodiments provide a system and method for capturing data from u sources, used for law enforcement, ERMT, governmental agencies, public health, and related emergency management organizations (UAVE) and/or commercial, individual, industrial or international UAV governance. The data could be captured watermarking the data, thus time stamping the data. In addition, the present invention could also be designed to perform “UA vehicle recognition” via video feeds in the same manner that “UAV recognition” software functions today. In another embodiment, smart technology, such as using a combination of active and passive RFID tags identifying information to be imbedded in a UA vehicles' license plate as well as the body of the vehicle. The UAVE system could provide emergency responders and or police with a multitude of information as previously described.

The systems proposed herein would be developed to harness and intelligently analyze the digital photo, audio, thermal, holographic magnetic resonance imaging, nano imaging, 3D imaging, nantomography and nanofabrication, high definition imaging and video information and other DDIC inputs from either the public and private sources mentioned above into a single or multiple databases based on location and function.

The information gathered from the DDIC inputs may be used to allow a manual response to an incident by a human user(s) or administrator(s) that receive input from the DDIC or an automated, networked or autonomous response by a specific technology (including, but not limited to robotic, unmanned vehicle (UV) and unmanned aerial vehicle (UAV) technology) or technologies that receive DDIC inputs.

Technically, the application potential for that data would be significant for a multitude of industries. A central computer integrating internal and external DDIC information databases with smart hierarchal protocols and methods could automate this activity with integrated software applications. DDIC data could run in real-time and be used as a repository of various Partner Location Servers, Location Appliances, Secure access and control servers and or wireless control systems designed for emergency or criminal response or other types of emergency and or non-emergency situations.

In addition, the system proposed herein will enable Public Safety Computer-aided Dispatch (CAD) systems and emergency response users using smartphone mobile and cellular devices which do not require voice 911 or voice emergency call centers but rather customizable emergency icons (such as gunman, assault, bomb threat, robbery etc.). The CAD system will be equipped with a software interface enabling the systems to read user based emergency alert information from smartphone devices. The user initiated alerts could be in the form of any robust type of information emulating from smart mobile devices and smart cellular devices as previously stated.

In another embodiment, the mobile/smart device could interface a multitude of sensors which identify one or more UAVs. The device could be triggered remotely by smart accessories, smart wearables and other devices. The unit could be remotely turned off, require a password, detect a different metabolism and other means of shutting off the device. In addition, the device when detecting another unauthorized user could automatically notify emergency responders. Emergency responders could track the device and or remotely turn the video and audio and other enriched data in stealth mode. This data in could be streamed to emergency responders enriched data to emergency personnel device in route and in process of apprehending the individual(s). Drone robots could be in a building or “campus”, “Campus” could be defined by any geographic territory, and could collect not only DDIC information but become a significant source of protection. Inside or on campus drone robots could be remotely guided to apprehend and or frighten the individual by bright lights, load sounds and other means. In addition, inside unmanned drones could be equipped with surveillance cameras, audio, and other technologies including but not limited to automated wireless guidance systems. The DDIC information from robotic drones could be integrated with all mobile devices and could integrate the DDIC information with defensive devices such as lockdown, sirens (voice commands) and other devices. In addition, mobile devices could be equipped with a Robotic Mobile Control System (RMCS) to override the computer system guiding the drone(s) depending on the type of situation, location and or emergency and or non-emergency. In addition, medical supplies and other equipment could be housed by the drone and delivered to the scene of the medical emergency and or non-emergency or situation. The RMCS system could include a one or more databases delivering medical instructions or a live expert or doctor who can visually (audibly) communicate through the drone device. The drone device in another embodiment could perform certain medical assistance or defensive assistance. Furthermore, the RMCS control system utilize all forms of commands including but limited to stealth commands from a mobile device or other secure demand from various authorized individuals.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

It will be further understood that various changes in the details, materials, and arrangements of the parts which have been described and illustrated in order to explain the nature of this invention may be made by those skilled in the art without departing from the scope of the invention as expressed in the claims to be filed upon the USPTO utility and International filing.

The invention claimed is:

1. A method of UAV (Unmanned Aerial Vehicle) enforcement, the method comprises:
detect interception of UAV in an area;
interfere when required UAV's GPD coordinate and positioning
allow authorized agent or personnel to alter/disable the UAV's GPS coordinates take, seize or halt a UAV on the way from one place to another
cut off one or more UAV's from an intend destination.

2. The invention of claim 1, wherein UAVE system functions could include listen or record (a transmitted communication received or transmitted) by the UAV(s)

3. The invention of claim 1, wherein UAVE system functions could include stop or interrupt the course, progress, communication and transmission of UAV(s)

4. The invention of claim 1, wherein UAVE system functions could include take possession of the UAV(s)

5. The invention of claim 1, wherein UAVE system functions could include catch or destroy, re-route capture, host, land, escort a UAV

6. The invention of claim 1, herein UAVE system functions could include mark, tag or identify UAV(s)

7. The invention of claim 1, wherein UAVE system functions could include prevent and or disable the operation or effect of UAV(s)

8. The invention of claim 1, wherein UAVE system functions could include cut off from access, sight of UAV(s)

9. The invention of claim 1, wherein UAVE system functions could include intercepted communication of UAV from public safety

10. The invention of claim 1, wherein UAVE system functions could include effectively intercepted, track or follow the UAV through various segments of a UAV's curve or route line.

11. The invention of claim 1, wherein UAVE system functions could include measure the origin to the point at which a curve or line intersects an axis

12. The invention of claim 1, wherein UAVE system functions could include track UAV's breadcrumb trail of flight Departure(s) Procedures and Coordinates (DPCs), and Standard Arrival Procedures and Coordinates (SAPCs) and other system.

13. The invention of claim 1, wherein UAVE system functions could represent a plurality of UAVE's could be activated from various physical standby base stations.

14. A system for UAVE, the system comprising:
Communication network control system in communication with UAV(s),
a detect system can disable, disarm, apprehend, detain, capture and hold harmless UAV(s) who have violated or is suspected to violate, harm and injure citizens and endanger public safety,
wherein the UAV(s) is adapted to transmit an indication of the suspecious situation to the communication network control system, and wherein the communication network control system is adapted to, (i) confirm the indication of the suspecious situation to the UAV(s), (ii) notify law enforcement personnel of the indication of the suspecious situation, (iii) transmits an indication of the suspecious situation to one or more additional UAVE(s) in the area, (iv) transmit periodic update indications of the situation to the one or more additional UAVE(s), wherein the one or more additional UAVE(s) are UAVE(s) within a predetermined physical range of the suspecious situation indicated by the UAV, and (v) transmit an indication of the situation to one or more local UAVE in the area, the local UAVE being in the vicinity of the suspecious situation.

15. The invention of claim 14, wherein the alert mode is activated by at least one of: a predefined command, a key press of a predefined duration, a predefined key press pattern, and an inertial movement of a predefined strength, and a secondary transmission, wherein the secondary transmission comprises:
activating an alert mode of a secondary transmission UAVE; and
transmitting, by the secondary transmission UAVE, an activation signal to the UAVE,
wherein the activation signal activates the alert mode of the UAVE;

16. The invention of claim 14, wherein the UAV further is adapted to record information related to the suspecious situation, wherein the recording of information related to the suspecious situation comprises recording at least one of audio information, video information, and location information

17. The invention of claim 14, wherein, when the alert mode is activated, the UAV is adapted to i) record information related to the suspecious situation, wherein the information includes at least one of audio information, video information, and location information, and ii) transmit the information to the communication network control system, wherein the information is recorded by communication network control system.

18. A method of UAVE, the method comprising:
a detect system can detect UAV(s) who have violated or is suspected to violate, harm and injure citizens and endanger public safety
transmitting, from the UAV, an indication of the suspicious or potential harmful situation to a communication network control system;
confirming, by the communication network control system, the indication of the suspicious or potential harmful situation to the UAV;
notifying, by the communication network control system, enforcement personnel of the indication of the suspicious or potential harmful situation; and transmitting, by the communication network control system, an indication of the suspicious or potential harmful situation to one or more additional UAV(s) in the area,
wherein the enforcement mode comprises:
deactivating or disable one or more output devices of the UAV(s)
disarm, apprehend, detain, capture and hold harmless UAV(s) who have violated or is suspected to violate, harm and injure citizens and endanger public safety.

19. An apparatus for UAVE system, the apparatus comprising:
a UAV is activated based on an suspicious or potential harmful situation in an area, the UAV is adapted to transmit an indication of the suspicious or potential harmful situation to a communication network control system,
wherein the communication network control system, i) a control system in monitoring UAV traffic, speed, any hazard situation or position measuring for public safety; ii) confirms the indication of the suspect situation to UAV, ii) notifies enforcement personnel of the indication of the suspicious or potential harmful situation, and iii) transmits an indication of the suspicious or potential harmful situation to one or more addition UAVE(S) in the area, and
wherein the UAVE comprises a UAV having alert mode wherein, upon entering alert mode, the UAVE is adapted to, i) deactivate or disable the UAV; ii) disarm the UAV; iii) apprehend, detain, capture and hold harmless UAV(s) who have violated or is suspected to violate, harm and injure citizens and endanger public safety.

20. A system for UAVE, the system comprising: a UAV having an alert mode that is activated based on an suspicious or potential harmful situation in an area, wherein the UAVE comprises: a control system in monitoring UAV traffic, speed, any hazard situation or position measuring;
A communication network system in communicating with the UAV, wherein the UAV is adapted to transmit an indication of the suspicious or potential harmful situation to the communication network control system, and wherein the communication network control system is adapted to, i) monitor and confirm the indication of the suspicious or potential harmful situation to the UAV, ii) notify enforcement personnel of the indication of the suspicious or potential harmful situation, and
iii) transmit an indication of the suspicious or potential harmful situation to one or more additional UAV(s) in the area,
wherein, upon entering alert mode, the UAVE is adapted to, i) deactivate or disable one or more output devices of the UAV, wherein the one or more output devices include one of these: a screen, a pressure sensor, a speed sensor, a status light, and a keypad backlight; and ii) transmit periodic update indications of the suspicious or potential harmful situation.
